(19) United States
(12) Patent Application Publication
(10) Pub. No.: US 2018/0132242 A1
(43) Pub. Date: May 10, 2018

(54) GROUPING OF SERVING CELLS WITH SHORTENED TRANSMISSION TIME INTERVALS

(71) Applicant: MEDIATEK INC., Hsin-Chu City (TW)

(72) Inventors: Chien-Chang Li, Magong City (TW); Weidong Yang, San Diego, CA (US); Bo-Si Chen, Keelung City (TW); Yih-Shen Chen, Zhubei City (TW)

(73) Assignee: MEDIATEK INC., Hsin-Chu City (TW)

(21) Appl. No.: 15/794,882

(22) Filed: Oct. 26, 2017

Related U.S. Application Data
(60) Provisional application No. 62/417,383, filed on Nov. 4, 2016.

(51) Int. Cl. H04W 72/04; H04W 76/02; H04W 24/10; H04L 5/00; H04L 1/18

(52) U.S. Cl. CPC H04W 72/0453; H04W 76/02; H04W 24/10; H04L 1/1812; H04L 5/0042; H04W 72/0413; H04L 5/001

(57) ABSTRACT

Aspects of the disclosure provide a method for grouping serving cells with shortened transmission time intervals in carrier aggregation. The method can include establishing a connection between user equipment and a base station on a primary cell in a wireless communication system, and transmitting a carrier aggregation configuration for configuring secondary cells for the user equipment from the base station to the user equipment, wherein serving cells with different downlink transmission time interval lengths are organized into different cell groups in the carrier aggregation configuration.

### INCORPORATION BY REFERENCE

This present disclosure claims the benefit of U.S. Provisional Application No. 62/417,383, “Grouping of Serving Cells in Shortened TTI” filed on Nov. 4, 2016, which is incorporated herein by reference in its entirety.

### TECHNICAL FIELD

The current disclosure describes carrier aggregation techniques in wireless communication networks. Specifically, the current disclosure describes techniques for grouping serving cells that have different shortened transmission time intervals (sTTI).

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Carrier aggregation and shortened transmission time interval (sTTI) techniques can be employed to improve performance of a wireless communication system, such as an LTE system. For example, carrier aggregation can increase the maximum data rate of a mobile device, while sTTI can decrease end to end delay for applications on a mobile device.

### SUMMARY

Aspects of the disclosure provide a method for grouping serving cells with shortened transmission time intervals (sTTI) in carrier aggregation (CA). The method can include establishing a connection between a user equipment (UE) and a base station on a primary cell (PCell) in a wireless communication system, and transmitting a CA configuration for configuring secondary cells (SCells) for the UE from the base station to the UE, wherein serving cells with different downlink transmission time interval (TTI) lengths are organized into different cell groups in the CA configuration.

Embodiments of the method can further include receiving from the UE hybrid automatic repeat request (HARD) acknowledgements or negative-acknowledgements (ACK/NACKs) for downlink data transmission of the serving cells with different TTI lengths on different serving cells.

In one example, serving cells with a same downlink TTI length are organized into a same or different cell groups in the CA configuration. Embodiments of the method can further include receiving from the UE HARQ ACK/NACKs for downlink data transmission of the serving cells with the same downlink TTI length on a same or different serving cells.

In one example, serving cells with different downlink TTI lengths are organized into different cell groups in the CA configuration. In one example, serving cells with different downlink-uplink TTI combinations are organized into different cell groups in the CA configuration. In one example, the different downlink-uplink TTI combinations include at least two of {2, 2}, {2, 4}, {2, 7}, {7, 2}, {7, 4}, or {7, 7}.

Aspects of the disclosure provide a second method for grouping serving cells with sTTI in CA. The method can include establishing a connection between a UE and a base station on a PCell in a wireless communication system, and transmitting uplink control information to the base station according to a CA configuration, wherein the uplink control information of serving cells with different downlink TTI lengths is transmitted separately on different serving cells.

Embodiments of the method can further include transmitting HARQ ACK/NACKs for downlink data transmission to the base station, wherein the HARQ ACK/NACKs for downlink data transmission of the serving cells with different TTI lengths are separately fed back to the base station on different serving cells.

In one example, the uplink control information of serving cells with a same downlink TTI length is transmitted on a same or different serving cells. Embodiments of the method can further include transmitting HARQ ACK/NACKs for downlink data transmission to the base station, wherein HARQ ACK/NACKs for downlink data transmission of the serving cells with the same downlink TTI length are fed back to the base station on a same or different serving cells.

In one example, the uplink control information of serving cells different downlink TTI lengths is transmitted separately on different serving cells. In one example, the uplink control information of serving cells with different downlink-uplink TTI combinations is transmitted on different serving cells. In one example, the different downlink-uplink TTI combinations include at least two of {2, 2}, {2, 4}, {2, 7}, {7, 2}, {7, 4}, or {7, 7}.

Aspects of the disclosure provide a UE that includes circuitry configured to establish a connection between the UE and a base station on a primary cell (PCell) in a wireless communication system, and transmit uplink control information to the base station according to a CA configuration, wherein the uplink control information of serving cells with different downlink TTI lengths is transmitted separately on different serving cells.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a wireless communication system according to an embodiment of the disclosure;

FIGS. 2A-2B illustrate problems that arises when carrier aggregation and shortened transmission time interval (TTI) techniques are used together;

FIGS. 3A-3B show cell grouping examples of serving cells with a same TTI length according to an embodiment of the disclosure;

FIG. 4 shows a cell grouping example of serving cells with different TTI length according to an embodiment of the disclosure;

FIG. 5 shows a cell group configuration process according to an embodiment of the disclosure;

FIG. 6 shows an example user equipment according to an embodiment of the disclosure; and

FIG. 7 shows an example base station according to an embodiment of the disclosure.

### DETAILED DESCRIPTION OF EMBODIMENTS

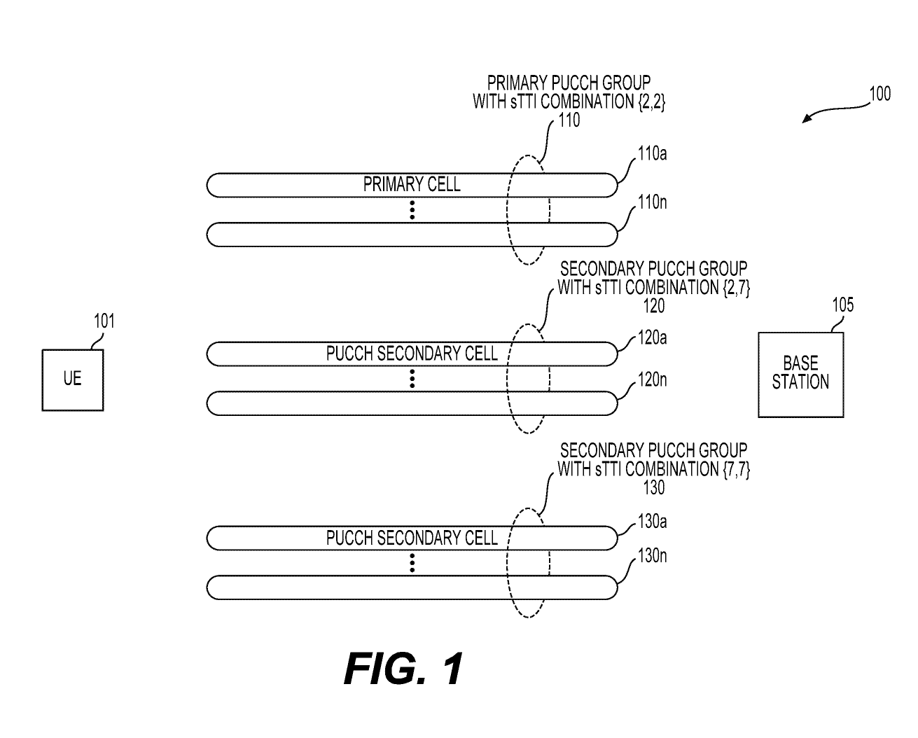

FIG. 1 shows a wireless communication system 100 according to an embodiment of the disclosure. The system 100 includes a user equipment (UE) 101 and a base station 105. The wireless communication system 100 can be a cellular network. The UE 101 can be a mobile phone, a laptop computer, a tablet computer, and the like. The base station 105 can be an implementation of an eNodeB in E-UTRAN of a long-term evolution (LTE) system, or an implementation of a gNB in new radio (NR) of a fifth generation (5G) system, or other types of base stations. The LTE E-UTRAN and the 5G NR are radio access network or radio interface specified in communication standards developed by the 3rd Generation Partnership Project (3GPP). Accordingly, the UE 101 can communicate with the base station 105 through a wireless communication channel according to communication protocols specified in respective communication standards.

In one example, the UE 101 and the base station 105 are configured to employ carrier aggregation techniques to communicate with each other. Accordingly, multiple serving cells 110a-110n, 120a-120n, and 130a-130n can be configured between the UE 101 and the base station 105. Each of the multiple serving cells can correspond to a downlink component carrier, and an uplink component carrier. Alternatively, a serving cell can be configured asymmetrically, and only an uplink component carrier or a downlink component carrier is transmitted on the respective serving cell. The uplink component carriers can be transmitted in parallel allowing for an overall wider uplink bandwidth and correspondingly higher uplink data rates. Similarly, the downlink component carriers can be transmitted in parallel allowing for an overall wider downlink bandwidth and correspondingly higher downlink data rates. Different serving cells can operate on frequency division duplex (FDD) mode or time division dulplex (TDD) mode. For serving cells configured with TDD mode, different uplink-downlink configurations can be used for different component carriers.

The multiple serving cells 110a-110n, 120a-120n, and 130a-130n include a primary cell (PCell) 110a. Other serving cells of the multiple serving cells are referred to as secondary cells (SCells). The PCell 110a can be established first, for example, after an initial access procedure, and the SCells can be subsequently configured and added through signaling on the PCell 110a. Depending on capability of the UE 101, different number of serving sells can be configured.

In one example, the multiple serving cells 110a-110n, 120a-120n, and 130a-130n are organized into different cell groups in order to increase capacity for transmission of uplink control information. For example, the serving cells 110a-110n are grouped into a first cell group 110, and the serving cells 120a-120n, and 130a-130n are grouped into a second cell group 120 and a third cell group 130, respectively. For the first cell group 110, the serving cell 110a can be used for carrying the uplink control information. For the second and third cell groups 120 and 130, a secondary serving cell is selected and designated, for example, by the base station 105, to carry uplink control information for the respective cell group 120 or 130. For example, the serving cell 120a and 130a can be designated to carry uplink control information for the cell groups 120 and 130, respectively. Except the primary cell 110a and the designated secondary cells 120a and 130a, other cells of the multiple serving cells 110a-110n, 120a-120n, and 130a-130n typically do not carry uplink control information.

When cell grouping is not used in carrier aggregation, only one serving cell, the primary cell 110a, is used for uplink control information transmission. In contrast, when cell grouping is configured, more than one serving cells can be configured for transmission of uplink control information. As a result, a capacity of uplink control information transmission is increased.

In one example, the system 100 is an LTE system, and the uplink control information of the cell groups 110-130 is carried on physical uplink control channels (PUCCHs) on the primary cell 110a and the designated serving cells 120a and 130a. Accordingly, the designated secondary cell 120a or 130as is referred to as a PUCCH secondary cell, and the cell group 110, 120, or 130 is referred to as a PUCCH cell group. On the primary cell 110a and the designated serving cells 120a and 130a, the PUCCH can be carried on each sub-frame when no uplink data blocks are transmitted. When there is an uplink data block being transmitted on a sub-frame, the uplink control information can share a same uplink data channel with a data block, thus no PUCCH is transmitted on the same sub-frame.

In the example, hybrid automatic repeat request (HARQ) scheme is used in each serving cell in both uplink and downlink directions. Accordingly, an hybrid autonomic repeat request (HARQ) acknowledgement or negative-acknowledgement (ACK/NACK) needs to be transmitted from the UE 101 to the base station 105 as a response to reception of a downlink data block on each serving cell. With cell groups configured, the HARQ ACK/NACK can be included in a PUCCH and fed back to the base station 105 on one of the primary cell 110a or the PUCCH secondary cells 120a and 130a. For example, if a downlink data block is received on one of the serving cells 120a-120n in the cell group 120, a PUCCH carried on an uplink component carrier on the PUCCH secondary cell 120a can be used to feed back the HARQ ACK/NACK.

In one example, the serving cells 110a-110n, 120a-120n, and 130a-130n are configured with shortened transmission time interval (sTTI). A TTI refers to a time period for preparing and processing a data block for transmission at a transmitter or a time period for processing and recovering a received data block at a receiver. The data block can be one of a sequence of data blocks that are sequentially transmitted from the transmitter to the receiver during a sequence of TTIs. In an LTE system, for example, a TTI can have a length of duration of a sub-frame equal to 1 ms, and each such sub-frame can include 14 orthogonal frequency division multiplexing (OFDM) symbols.

When sTTI is employed, a sub-frame with a 1 ms TTI length can further be divided into sub-frames with a shorter TTI length. For example, instead of having 14 OFDM symbols in one TTI, a sTTI can have 7, 4, or 2 OFDM symbols thus having a shorter length in time. Employment of sTTI in the system 100 can decrease end to end delay for applications operating on the UE 101 according to an aspect of the disclosure. In FIG. 1 example, each serving cell can be configured with a same or different downlink-uplink TTI combination. For example, a downlink-uplink sTTI combination can be {2, 2}, {2, 4}, {2, 7}, {7, 2}, {7, 4}, or {7, 7}, where the numbers represent the numbers of OFDM symbols indicating different TTI lengths, and the former and latter TTI lengths in each pair correspond to a downlink and uplink sTTI, respectively.

In one example, the serving cells 110a-110n, 120a-120n, and 130a-130n are grouped into the cell groups 110-130 according to downlink sTTI lengths. Specifically, serving cells with different downlink TTI lengths can be grouped into different cell groups, while serving cells with a same downlink TTI length can be grouped into a same or different cell groups. In addition, when grouping serving cells with a same downlink TTI length into different cell groups, serving cells with different uplink TTI lengths can be grouped into different cell groups.

For example, the serving cells 130a-130n have a downlink TTI length of 7 OFDM symbols, while the serving cells 110a-110n and 120a-120n have a downlink TTI length of 2 OFDM symbols. Accordingly, the serving cells 130a-130n and the serving cells 110a-110n and 120a-120n are organized into separate groups as shown in FIG. 1. For the serving cells 110a-110n and 120a-120n having the same downlink TTI length of 2 OFDM symbols, the serving cells 110a-110n and 120a-120n can be divided into different groups or kept in one group. In FIG. 1 example, the serving cells 110a-110n and 120a-120n are grouped into two cell groups 110 and 120. Particularly, the serving cells 110a-110n having an uplink TTI length of 2 OFDM symbols are grouped into the cell group 110, while the serving cells 120a-120n having an uplink TTI length of 7 OFDM symbols are grouped into a separate cell group, the cell group 120. As a result, serving cells with different downlink-uplink sTTI combinations, namely {2, 2}, {2, 7}, or {7, 7}, are grouped into different cell groups 110-130 in FIG. 1 example.

In an alternative example, each of the serving cells 110a-110n, 120a-120n, and 130a-130n has a different downlink sTTI length. Accordingly, each of the serving cells 110a-110n, 120a-120n, and 130a-130n is organized into a different cell group. Each such cell group includes only one serving cell. In a further example, all the serving cells 110a-110n, 120a-120n, and 130a-130n has a same downlink sTTI length. Accordingly, the serving cells 110a-110n, 120a-120n, and 130a-130n can be grouped into one or more cell groups.

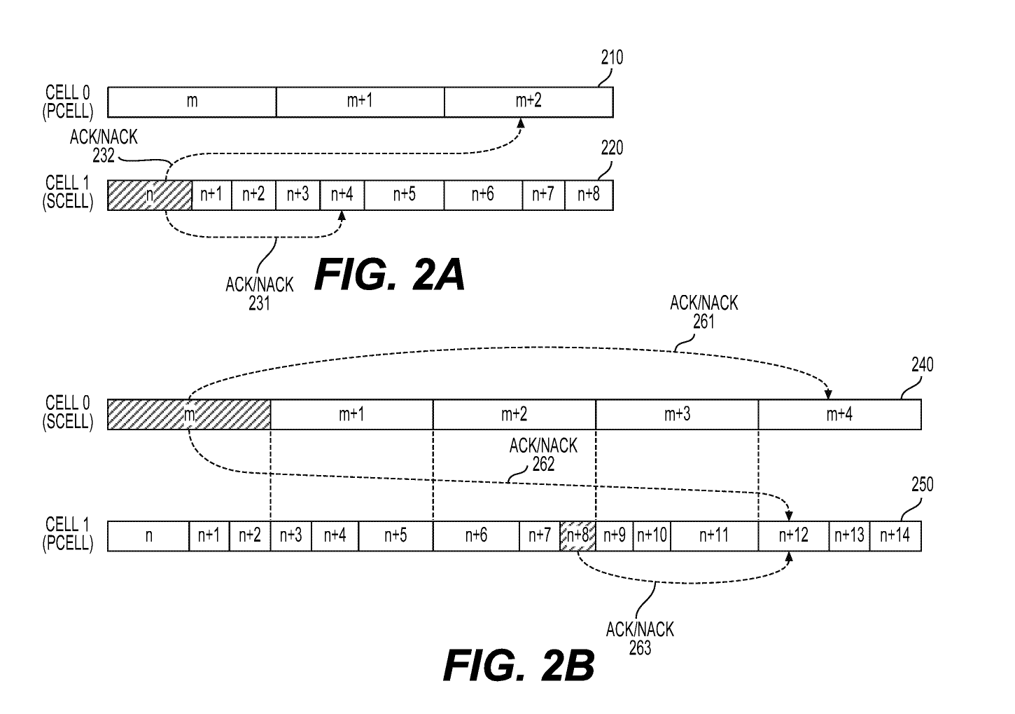

FIGS. 2A-2B illustrate problems arising when carrier aggregation and sTTI techniques are used together. FIG. 2A illustrates an ARQ ACK/NACK delay issue that takes place when serving cells with different sTTI lengths are grouped into a cell group in a carrier aggregation configuration. In FIG. 2A example, a first serving cell, cell 0, and a second serving cell, cell 1, are grouped into a cell group. Cell 0 is configured to be a PCell, and Cell 1 is subsequently added as a SCell. Accordingly, transmission of uplink control information and HAQR ACK/NACKs can be carried on cell 0. A first sequence of sub-frames 210 with an sTTI length of 7 OFDM symbols are transmitted from Cell 0 in uplink direction. A second sequence of sub-frames 220 with an sTTI length of 2 OFDM symbols are transmitted from Cell 1 also in uplink direction. The HARQ scheme is employed on both cell 0 and cell 1.

Assuming a downlink data block is received from a base station at the TTI n on cell 1, an HACK/NACK needs to be fed back to the base station. If cell 1 is not part of the carrier aggregation configuration and operates independently, the ACK/NACK can be prepared and get ready before TTI n+4, and transmitted during TTI n+4, as indicated by an arrow 231. However, as cell 0 and cell 1 are formed into a cell group, the ACK/NACK needs to be fed back on cell 0. When sub-frame m+1 starts to be transmitted, the ACK/NACK has not been ready. Consequently, the ACK/NACK is carried in sub-frame m+2 and transmitted during TTI m+2, as indicted by an arrow 232. As a result, transmission of the ACK/NACK is delayed from TTI n+4 to TTI m+2, which contradicts the purpose of using sTTI for latency reduction.

FIG. 2B illustrates a capacity issue for transmission of HAQR ACK/NACK that also takes place when serving cells with different sTTI lengths are grouped into a same cell group in a carrier aggregation configuration. In FIG. 2B example, a first serving cell, cell 0, and a second serving cell, cell 1, are grouped into a cell group. Cell 1 is configured to be a PCell, and Cell 0 is subsequently added as a SCell. Accordingly, transmission of uplink control information and HAQR ACK/NACKs can be carried on cell 1. A first sequence of sub-frames 240 with an sTTI length of 7 OFDM symbols are transmitted from Cell 0 in uplink direction. A second sequence of sub-frames 250 with an sTTI length of 2 OFDM symbols are transmitted from Cell 1 also in uplink direction. The HARQ scheme is employed on both cell 0 and cell 1.

Assuming a downlink data block is received from a base station at the TTI m on cell 0, an ACK/NACK needs to be fed back to the base station. If cell 0 is not part of the carrier aggregation configuration and operate independently, the ACK/NACK can be prepared and get ready before TTI m+4, and transmitted during TTI m+4, as indicated by an arrow 261. However, as cell 0 and cell 1 are formed into a cell group, the ACK/NACK needs to be fed back on cell 1. Accordingly, the ACK/NACK is carried in sub-frame n+12 and transmitted during TTI n+12, as indicted by an arrow 262. Similarly, it can be seen that traffic of ACK/NACKs corresponding to data blocks received from the base station on cell 0 turns to be carried on TTI n, TTI n+3, TTI n+6, TTI n+9, each of which starts around a same time as a corresponding sub-frame on cell 0, such as sub-frames m, m+1, m+2, m+3, respectively. At the same time, assuming another downlink data block is received from the base station on cell 1 at TTI n+8, an ACK/NACK needs to be transmitted during the same TTI n+12. Similarly, each of the sub-frames of the sequence 250 needs to carry an ACK/NACK corresponding to a data block received on cell 1.

As can be seen, when member serving cells having a TTI of 7 OFDM symbols in the cell group are large, traffic of a plurality of ACK/NACKs may be focused on a subset of TTIs of cell 1, such as TTI n, TTI n+3, TTI n+6, TTI n+9. As TTIs of cell 1 are shortened TTIs having a short length of 2 OFDM symbols, there can be insufficient transmission resources for transmission of a large amount of ACK/NACKs.

According to an aspect of the disclosure, in order to solve the issues illustrated in FIG. 2A and FIG. 2B examples, HARQ ACK/NACKs of serving cells with different uplink TTI lengths can be separately fed back with separate PUCCH channels on separate serving cells. To do so, the method described in FIG. 1 example can be employed where serving cells with different uplink TTI lengths are grouped into different cell groups 110-120. As a result, HARQ ACK/NACKs of serving cells with different uplink TTI lengths are fed back separately on the primary cell 110a, or the PUCCH secondary cell 120a. In this manner, the delay issue and capacity issue can be solved.

While uplink transmission of ACK/NACKs are used as examples for illustrating the delay issue and the capacity issue in FIGS. 2A-2B examples, the issues also exist for downlink transmission of ACK/NACKs. For example, a cross carrier scheduling scheme can be employed in a cell group in a carrier aggregation configuration. Accordingly, ACK/NACKs corresponding to receptions of data blocks from multiple uplink component carriers belonging to a same cell group can be carried on downlink component carrier of a primary cell or a designated cell of the cell group. For example, in LTE system, a physical hybrid-ARQ indicator channel (PHICH) is used for carrying the ACK/NACKs which is carried on a downlink component carrier of a primary cell or a designated cell of the cell group. Thus, similar issues, such as the delay issue and the capacity issue related with ACK/NACK feedback, can arise.

According to the disclosure, in order to solve the delay issue and capacity issue associated with downlink ACK/NACK transmission, serving cells with different downlink TTI length can be grouped into different cell groups. Accordingly, as described in FIG. 1 example, the serving cells 130a-130n having the downlink TTI length of 7 OFDM symbols and the serving cells 110a-110n and 120a-120n having the downlink TTI length of 2 OFDM symbols are grouped into different groups.

As a result of implementing the above cell grouping methods on both uplink and downlink directions, serving cells belonging to each resultant cell group can have a same uplink TTI length and a same downlink TTI length. In other words, as a result of cell grouping operations according to uplink TTI lengths and downlink TTI lengths, serving cells having a same downlink-uplink sTTI combination are grouped into a same cell group.

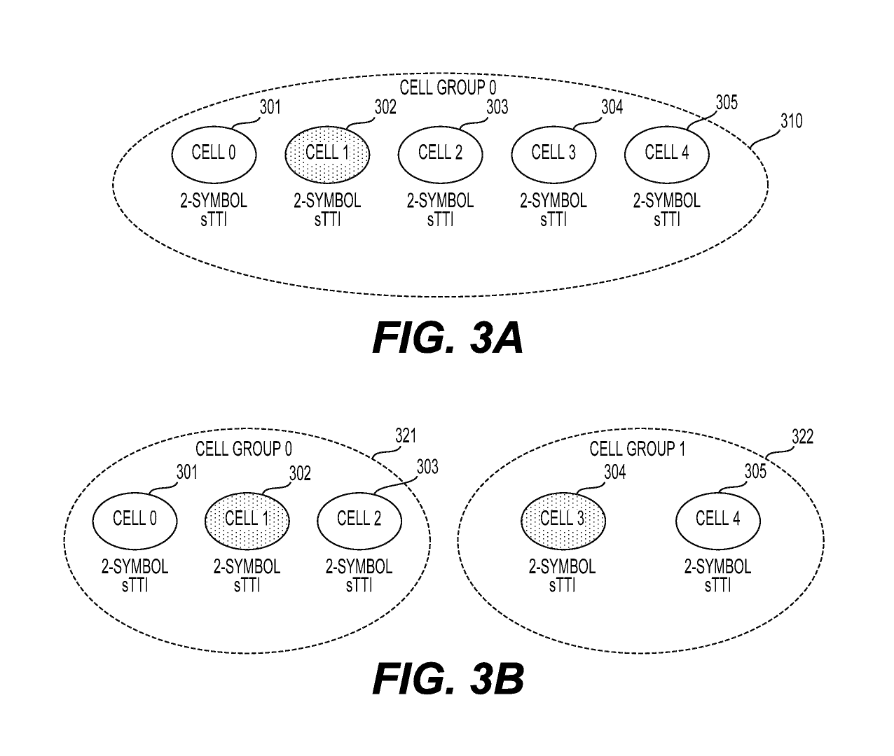

FIGS. 3A-3B show cell grouping examples of serving cells with a same TTI length according to an embodiment of the disclosure. FIGS. 3A-3B show five serving cells 301-305 each having a TTI length of 2 OFDM symbols. The group of TTIs in FIGS. 3A-3B examples can be either a group of uplink TTIs or a group of downlink TTIs. As the serving cells 301-305 have the same TTI length, the serving cells 301-305 can be grouped in a same cell group or divided into different groups. In FIG. 3A, the serving cells 301-305 are organized into one cell group 310, and the serving cell 302 is configured with a PUCCH for carrying uplink or downlink control information that can carry HARQ ACK/NACKs. In contrast, in FIG. 3B, the serving cells 301-305 are organized into two cell groups 321 and 322. The first cell group 321 includes serving cells 301-303 where the serving cell 302 is configured to carry a PUCCH. The second group 322 includes serving cells 304-305 where the serving cell 304 is configured to carry a PUCCH.

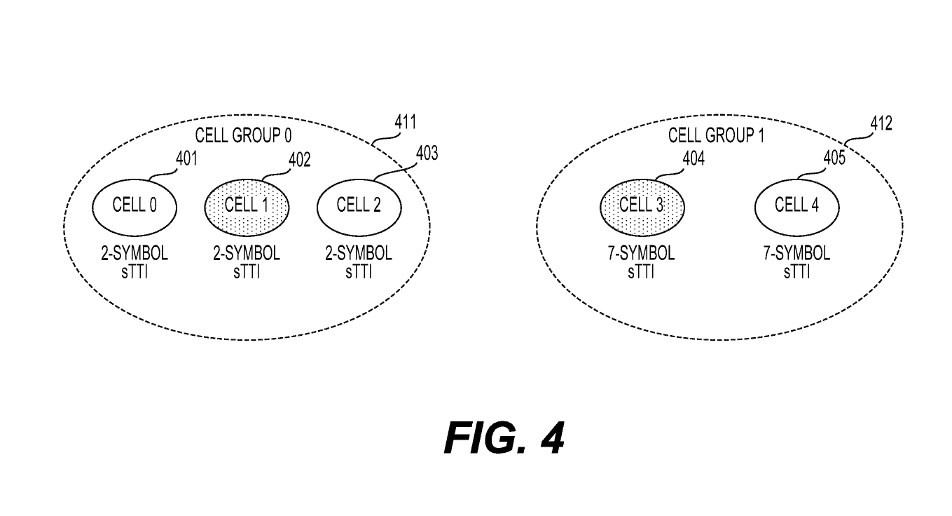

FIG. 4 shows a cell grouping example of serving cells with different downlink TTI length according to an embodiment of the disclosure. FIG. 4 similarly shows five serving cells 401-405, however the serving cells 401-405 have different TTI lengths. The serving cells 401-403 have a TTI length of 2 OFDM symbols while the serving cells 404-405 have a TTI length of 7 OFDM symbols. Accordingly, the serving cells 401-403 are grouped into a first cell group 411, while the serving cells 404-405 are grouped into a second cell group 412. Cell 402 and cell 404 are each configured with a PUCCH for transmission of control information of the cell group 411 and the cell group 412, respectively.

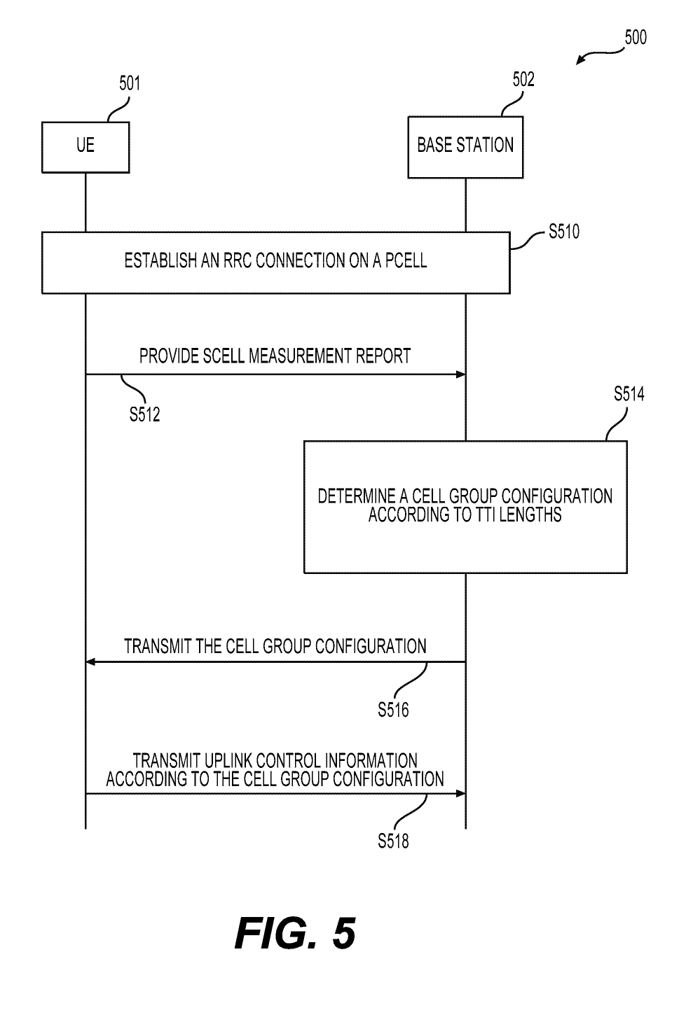

FIG. 5 shows a cell group configuration process 500 according to an embodiment of the disclosure. The process 500 can be performed by a UE 501 and a base station 502 to group serving cells into groups according to TTI lengths of the serving cells.

At S510, a radio resource control (RRC) connection can be established on a primary cell. For example, after a random access process, a three way handshake procedure can be performed. The UE 501 can send an RRC connection request to the base station 502 which transmits an RRC connection setup message to the UE 501 as a response. The UE 501 can then transmit an RRC connection complete message and become connected to the base station.

At S512, an SCell measurement report can be provided by the UE 501 to the base station 502. For example, the UE 501 can receive a list of downlink component carriers from the base station 502 via the RRC connection. Each downlink component carrier corresponds to a candidate secondary cell that can be potentially aggregated with the primary cell for carrier aggregation purpose. The UE 501 measures signal qualities of the component carriers and reports the measurement results to the base station 502.

At S514, a cell group configuration can be determined at the base station 502. For example, based on the measurement report and capability of the UE 501, a subset of the potential candidate secondary serving cells can be selected for aggregation with the primary cell. Subsequently, or simultaneously, sTTI configuration (downlink and uplink TTI lengths) can be determined for the serving cells (the primary cell and the selected secondary cells). For example, based on downlink carrier quality measurements, capability of the UE 501, requirements of the UE 501 (e.g., application delay requirement), sTTI configurations for the serving cells can be determines. Thereafter, the cell group configuration can be determined according to TTI lengths of each serving cell.

Specifically, serving cells can be grouped into cell groups in a way similar to what is described in FIG. 1, FIGS. 3A-3B, and FIG. 4 example. For example, serving cells having different downlink TTI lengths are grouped into different cell groups. Serving cells having a same downlink TTI length can be grouped into a same or different cell groups.

In addition, the cell group configuration can also specify a serving cell designated for transmission of uplink control information for cell groups not including the primary cell. For example, the designated serving cells or the primary cell can each carry a PUCCH that can carry HARQ ACK/NACK information.

At S516, the cell group configuration is transmitted from the base station 502 to the UE 501. In one example, the cell group configuration is carried in an RRC message.

At S518, uplink control information is transmitted from the UE 501 to the base station 502 according to the cell group configuration. For example, in a cell group including the primary cell, uplink control information, such as PUCCH feedback of ACK/NACKs, can be transmitted on the primary cell, while in a cell group including a designated serving cell, such as a PUCCH secondary serving cell, uplink control information, such as PUCCH feedback of ACK/NACKs, can be transmitted on this designated serving cell. For example, according to the cell group configuration, uplink control information (such as the HARQ ACK/NACKs for downlink data transmission) of the serving cells with different downlink TTI lengths can be separately transmitted to the base station on different serving cells. In addition, uplink control information (such as ARQ ACK/NACKs for downlink data transmission) of the serving cells with the same downlink TTI lengths can be transmitted to the base station on a same or different serving cells. For example, uplink control information of serving cells with different downlink-uplink sTTI combinations can be transmitted to the base station on different serving cells.

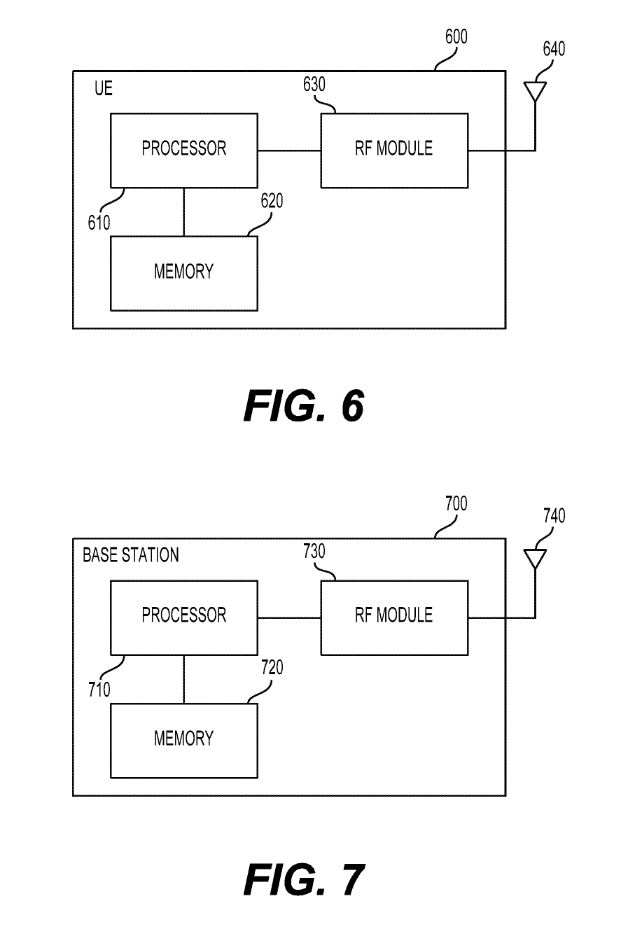

FIG. 6 shows an example UE 600 according to an embodiment of the disclosure. The UE 600 can implement various embodiments of the disclosure. The UE 600 can include a processor 610, a memory 620, and a radio frequency (RF) module 630. Those components are coupled together as shown in FIG. 6. In different examples, the UE 600 can be a mobile phone, a tablet computer, a desktop computer, a vehicle carried device, and the like.

The processor 610 can be configured to perform functions of the UE 501 in FIG. 5 example. For example, the processor 610 can perform a RRC connection establishment process to setup an RRC connection with a base station on a primary cell. The processor 610 can perform a measurement process to measure signal qualities of downlink component carrier signals received from a base station for carrier aggregation purpose.

The processor 610 can receive a cell group configuration carried in an RRC message from a base station and accordingly transmit uplink control information according to the cell group configuration. For example, the processor 610 can prepare PUCCH information and transmit the PUCCH information on PUCCH secondary cells and primary cells as specified by the cell group configuration. Specifically, the processor 610 can generate ACK/NACKs based on reception of downlink data blocks and feedback those ACK/NACKs on the PUCCH secondary cells or primary cells.

In addition, the processor 610 can process received or to-be-transmitted data blocks in accordance to sTTI configurations. The processor 610 can be implemented with hardware, software, or a combination thereof. The processor 610 can be implemented with application specific integrated circuits (ASIC), field programmable gate arrays (FPGA), and the like, that include circuitry. The circuitry can be configured to perform various functions described herein.

In one example, the memory 620 can store program instructions that cause the processor 610 to perform various functions. The memory 620 can include read only memory (ROM), random access memory (RAM), flash memory, a hard disk drive, and the like. The RF module 630 can receive a digital signal from the processor 610 and transmits the signal to a base station in a wireless communication network via an antenna 640, or receive a wireless signal from a base station and accordingly generates a digital signal which is supplied to the processor 610. The RF module 630 can include digital to analog (DAC)/analog to digital (CAD) converters, frequency down/up converters, filters, and amplifiers for reception and transmission operations. The UE 600 can optionally include other components, such as input and output devices, additional CPU or signal processing circuitry, and the like. Accordingly, the UE 600 may be capable of performing other additional functions, such as executing application programs, and processing alternative communication protocols.

FIG. 7 shows an example base station 700 according to an embodiment of the disclosure. The base station 700 can implement various embodiments of the disclosure. Similarly, the base station 700 can include a processor 710, a memory 720, and a radio frequency (RF) module 730. Those components are coupled together as shown in FIG. 7. In different examples, the base station can be an eNodeB in an LTE network, a gNB in a NR network, and the like.

The processor 710 can be configured to perform functions of the base station 502 in FIG. 5 example. For example, the processor 710 can perform a RRC connection establishment process to setup an RRC connection with a UE on a PCell. The processor 710 can receive a SCell quality measurement report from the UE. The processor 710 can select a subset of serving cells transmitted from the base station 700 based on the received SCell quality measurement report. The selected serving cells can be used as SCells to be aggregated with the primary cell. The processor 710 can determine sTTI configurations for the serving cells of the UE (the selected SCells and the PCell), and subsequently determine a cell group configuration according to TTI lengths of the serving cells of the UE.

In addition, a serving cell can be designated for transmission of uplink control information for each of the cell groups that do not include the PCell. Finally, the processor 710 can transmit the cell group configuration to the UE such that the UE can transmit uplink control information on the cells specified by the cell group configuration. The processor 710 can be implemented with hardware, software, or a combination thereof. The processor 710 can be implemented with application specific integrated circuits (ASIC), field programmable gate arrays (FPGA), and the like, that include circuitry. The circuitry can be configured to perform various functions described herein.

In one example, the memory 720 can store program instructions that cause the processor 710 to perform various functions. Similarly, the memory 720 can include read only memory (ROM), random access memory (RAM), flash memory, a hard disk drive, and the like. The RF module 730 can have functions and structure similar to that of the RF module 630. However, the RF module 730 can have functions and structures more suitable for performance of the base station 700. For example, the RF module 730 can have a higher transmission power for coverage of a large serving area, or support more downlink or uplink component carriers. The RF module 730 can receive or transmit wireless signals via an antenna 740.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method, comprising:
establishing a connection between a user equipment (UE) and a base station on a primary cell (PCell) in a wireless communication system; and
transmitting a carrier aggregation (CA) configuration for configuring secondary cells (SCells) for the UE from the base station to the UE, wherein serving cells with different downlink transmission time interval (TTI) lengths are organized into different cell groups in the CA configuration.

2. The method of claim 1, further comprising:
receiving from the UE hybrid automatic repeat request (HARQ) acknowledgements or negative-acknowledgements (ACK/NACKs) for downlink data transmission of the serving cells with different TTI lengths on different serving cells.

3. The method of claim 1, wherein serving cells with a same downlink TTI length are organized into a same or different cell groups in the CA configuration.

4. The method of claim 3, further comprising:
receiving from the UE HARQ ACK/NACKs for downlink data transmission of the serving cells with the same downlink TTI length on a same or different serving cells.

5. The method of claim 1, wherein serving cells with different downlink TTI lengths are organized into different cell groups in the CA configuration.

6. The method of claim 1, wherein serving cells with different downlink-uplink TTI combinations are organized into different cell groups in the CA configuration.

7. The method of claim 6, wherein the different downlink-uplink TTI combinations include at least two of {2, 2}, {2, 4}, {2, 7}, {7, 2}, {7, 4}, or {7, 7}.

8. A method, comprising:
establishing a connection between a user equipment (UE) and a base station on a primary cell (PCell) in a wireless communication system; and
transmitting uplink control information to the base station according to a carrier aggregation (CA) configuration, wherein the uplink control information of serving cells with different downlink transmission time interval (TTI) lengths is transmitted separately on different serving cells.

9. The method of claim 8, further comprising:
transmitting hybrid automatic repeat request (HARQ) acknowledgements or negative-acknowledgements (ACK/NACKs) for downlink data transmission to the base station,
wherein the HARQ ACK/NACKs for downlink data transmission of the serving cells with different TTI lengths are separately fed back to the base station on different serving cells.

10. The method of claim 8, wherein the uplink control information of serving cells with a same downlink TTI length is transmitted on a same or different serving cells.

11. The method of claim 10, further comprising:
transmitting HARQ ACK/NACKs for downlink data transmission to the base station,
wherein HARQ ACK/NACKs for downlink data transmission of the serving cells with the same downlink TTI length are fed back to the base station on a same or different serving cells.

12. The method of claim 8, wherein the uplink control information of serving cells with different downlilnk TTI lengths is transmitted separately on different serving cells.

13. The method of claim 8, wherein the uplink control information of serving cells with different downlink-uplink TTI combinations is transmitted on different serving cells.

14. The method of claim 13, wherein the different downlink-uplink TTI combinations include at least two of {2, 2}, {2, 4}, {2, 7}, {7, 2}, {7, 4}, or {7, 7}.

15. A user equipment (UE), comprising circuitry configured to:
establish a connection between the UE and a base station on a primary cell (PCell) in a wireless communication system; and
transmit uplink control information to the base station according to a carrier aggregation (CA) configuration, wherein the uplink control information of serving cells with different downlink transmission time interval (TTI) lengths is transmitted separately on different serving cells.

16. The UE of claim 15, wherein the circuitry is further configured to:
transmit hybrid automatic repeat request (HARQ) acknowledgements or negative-acknowledgements (ACK/NACKs) for downlink data transmission to the base station,
wherein the HARQ ACK/NACKs for downlink data transmission of the serving cells with different downlink TTI lengths are separately fed back to the base station on different serving cells.

17. The UE of claim 15, wherein the uplink control information of serving cells with a same downlink TTI length is transmitted on a same or different serving cells.

18. The UE of claim 17, wherein the circuitry is further configured to:
transmit HARQ ACK/NACKs for downlink data transmission to the base station,
wherein HARQ ACK/NACKs for downlink data transmission of the serving cells with the same downlink TTI length are fed back to the base station on a same or different serving cells.

19. The UE of claim 15, wherein the uplink control information of serving cells with different downlink TTI lengths is transmitted separately on different serving cells.

20. The UE of claim 15, wherein the uplink control information of serving cells with different downlink-uplink TTI combinations is transmitted separately on different serving cells.
